(19) United States
(12) Patent Application Publication
(10) Pub. No.: US 2009/0245697 A1
(43) Pub. Date: Oct. 1, 2009

(54) PACKAGING BAG MATERIAL AND PACKAGE WITH A CARRYING HANDLE USING THE PACKAGING BAG MATERIAL

(76) Inventors: Ryohei Yamazumi, Osaka (JP); Shukuro Ishihata, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/309,100

(22) PCT Filed: Nov. 7, 2007
(86) PCT No.: PCT/JP2007/071622

§ 371 Date: Jan. 7, 2009

(30) Foreign Application Priority Data
Nov. 8, 2006 (JP) 2006-302690

(51) Int. Cl. B65D 33/10; B32B 1/08

(52) U.S. Cl. 383/7; 428/35.2

(57) ABSTRACT

A packaging bag material which can be formed into packages each having a carrying handle and which can be wound into a roll and then continuously unwound.

The packaging bag material includes an elongated tube body 6 made of a resin film and including a front sheet 1 and a back sheet 2. A sheet strip 3 is disposed between portions of the front and back sheets extending from a first heat-bonded portion 4 toward a second side edge with the longitudinal direction of the strip sheet 3 coincident with the longitudinal direction of the tube body. The front and back sheets 1 and 2 are bonded to the sheet strip 3 at bonded portions 7 having a predetermined length and longitudinally spaced from each other with a predetermined pitch, thereby defining unbonded portions 8 between the adjacent bonded portions 7. This bag material 10 thus comprises a large number of bags connected to each other arranged in a row in the longitudinal direction. The portion of the sheet strip 3 at each unbonded portion 8 serves as a carrying handle.

### TECHNICAL FIELD

This invention relates to a packaging bag material used e.g. as rice bags, more specifically a packaging bag material which can be formed into packaging bags each having a carrying handle, and which makes it possible to continuously fill the bags using an automatic weighing/packaging machine by unwinding the bag material, which has been wound into a roll, and a package with a carrying handle formed from the packaging bag material.

### BACKGROUND ART

Packaging bags are known which can be hermetically or nearly hermetically sealed with rice or other products kept therein and having a carrying handle. The below-identified Patent documents 1 and 2 disclose such bags.

Patent document 1 discloses as prior art two packaging bags. One of them is in the form of a tube made of a film. Its top is sealed by superposing two layers, and a hole is formed in the sealed portion into which the palm of a hand can be inserted to provide a carrying handle. The other of the two packaging bags includes a separate carrying handle mounted to the top open edge. Patent document 1 further discloses a packaging bag in accordance with this invention which includes V-shaped gussets formed by folding a plastic film, and a top wall as a carrying handle formed by folding a film in a V shape. The V-shaped film is inserted in the V-shaped gussets and heat-sealed to the lower portion of a strip portion provided at the top of the bag.

Patent document 2 is a patent application filed by the applicant of the present invention and discloses a packaging bag comprising a bag body formed of a tube-shaped film, and a carrying handle formed of a tape of a synthetic resin and provided at the top of the bag body. The carrying handle has its ends inserted between opposed surfaces (between two superposed films) of the bag body and heat-sealed thereto.

Patent document 1: JP Patent Publication 7-329988A
Patent document 2: JP Patent Publication 2005-29193A

### DISCLOSURE OF THE INVENTION

### Object of the Invention

The packaging bags disclosed in Patent documents 1 and 2 are separate flat sheet-shaped bags. It is difficult to efficiently fill such bags.

An automatic weighing/packaging machine called a roll packer is known which is used to heat-seal and cut a roll of tube-shaped bag material comprising superposed elongated front and back sheets along lines that correspond to the bottom edges of the respective bags formed, while continuously unwinding the roll, fill the thus formed bags with weighed products, and heat-bond the top edges of the respective bags. Using this machine, the bags can be filled efficiently. While this roll packer can continuously feed a roll of bag material, it cannot efficiently fill packaging bags with a carrying handle as disclosed in Patent document 1 because these bags have top and bottom walls, the carrying handle is provided at the top edge of each bag, and the bags have to be handled separately from each other.

This roll packer cannot efficiently fill packaging bags with a carrying handle as disclosed in Patent document 2 either, because these bags have a carrying handle comprising a resin tape and provided on the top edge of each bag, and thus a plurality of them cannot be connected together in the longitudinal direction so as to be continuously fed by the roll packer.

An object of this invention is to provide a packaging bag material with carrying handles which can be wound into a roll and continuously unwound, thereby improving the work efficiency, and a packaging bag with a carrying handle formed of the packaging bag material.

### Means to Achieve the Object

In order to achieve this object, the present invention provides a packaging bag material comprising an elongated flat tube body made of a resin film and including a front sheet and a back sheet, and a sheet strip forming a carrying handle, wherein the tube body has first and second side edges, and a first heat-bonded portion where portions of the front and back sheets adjacent to the second side edge are bonded to each other, the first heat-bonded portion being spaced apart from the second side edge toward the first side edge in the width direction by a predetermined distance, wherein the sheet strip is disposed between portions of the front and back sheets extending from the first heat-bonded portion toward the second side edge with a longitudinal direction of the strip sheet coincident with a longitudinal direction of the tube body, and wherein the front and back sheets are bonded to the sheet strip disposed therebetween at bonded portions having a predetermined length and longitudinally spaced from each other with a predetermined pitch, thereby defining unbonded portions between the adjacent bonded portions, whereby the sheet strip can be pulled out from between the front and back sheets through the respective unbonded portions, the entire packaging bag material can be wound into a roll, and a packaging bag with a carrying handle can be formed by cutting the bag member in a direction perpendicular to the longitudinal direction of the tube body along a line between any adjacent unbonded portions and heat-sealing the front and back sheet together at their portions adjacent to and along the cut line.

Preferably, the sheet strip has a width that is equal to or smaller than the dimension of the portion of the tube body from the first heat-bonded portion to the second side edge and does not protrude from between the front and back sheets.

Many packaging bags filled with e.g. uncooked grains are formed with air vent holes in order not to hinder biological reactions of the grains and to release gases produced from the grains and air that may mix into the bags when the bags are filled, thereby preventing expansion and bursting of the bags. If it is necessary to form such air vent holes, the first heat-bonded portion may be divided into a plurality of longitudinally spaced apart sections, thereby defining air vent holes between the adjacent sections. The air vent holes should be of a size small enough not to allow spilling of the contents of the bag therethrough. The tube body may further have a second heat-bonded portion where the front and back sheets are joined to each other along the first side edge. In addition to or instead of the first heat-bonded portions, the second heat-bonded portion may be divided into a plurality of longitudinally spaced apart sections, thereby defining air vent holes between the adjacent sections.

The present invention also provides a package with a carrying handle formed by cutting the above-described packaging bag material in the direction perpendicular to the longitudinal direction of the tube body along two cut lines each between adjacent ones of the unbonded portions, filling a bag, heat-sealing the front and back sheets together at their portions adjacent to the respective two cut lines, thereby forming a bag of which all the four sides are closed, and the sheet strip can be pulled out from between the front and back sheets as a carrying handle.

The package with a carrying handle of the embodiment is a rice bag. But the package according to the invention may be used to contain grains other than rice or products other than grains.

### Advantages of the Invention

Because the tube body has first and second side edges, and a first heat-bonded portion where portions of the front and back sheets adjacent to the second side edge are bonded to each other, the first heat-bonded portion being spaced apart from the second side edge toward the first side edge in the width direction by a predetermined distance, the sheet strip is disposed between portions of the front and back sheets extending from the first heat-bonded portion toward the second side edge with a longitudinal direction of the strip sheet coincident with a longitudinal direction of the tube body, and the front and back sheets are bonded to the sheet strip disposed therebetween at bonded portions having a predetermined length and longitudinally spaced from each other with a predetermined pitch, thereby defining unbonded portions between the adjacent bonded portions, the sheet strip can be pulled out from between the front and back sheets through the respective unbonded portions as a carrying handle.

Because the sheet strip is disposed between the front and back sheets not along a top edge of each bag formed but along its side edge, the bag material can be formed integrally such that its portions to be formed into respective bags are joined together along their respective top and bottom edges. Since such a bag material can be wound into a roll. This in turn makes it possible to efficiently fill the bags with an automatic weighing/packaging machine (roll packer) while unwinding the roll of bag material.

By disposing the sheet strip between the front and back sheets so as not to protrude from the front and back sheets, the sheet strip will not be an obstacle when winding and unwinding the bag material.

By forming air vent holes in the first and/or second heat-bonded portions of the tube body, air that may mix into the bags when filling the bags is spontaneously released. This prevents bursting of the bags when they are stacked, which is a major problem when stacking the bags. The air vent holes also serve to allow breathing of uncooked grains that shows biological reactions in the bags, thus slowing deterioration in quality of the grains. The air vent holes also prevent expansion and bursting of the bags due to gases that may be produced from the grains.

A package formed from the packaging bag material according to this invention can be easily hand-carried because it has a carrying handle. Also, before the sheet strip is used as the carrying handle, it is covered and concealed by the front and back sheets. Thus, the sheet strip will not be an obstacle when filling the package and also does not worsen the appearance of the package.

Further, since the sheet strip has both ends thereof disposed between and heat-bonded to the front and back sheets, by increasing the area of the bonded portions, it is possible to increase the bond strength of the sheet strips to the front and back sheets, which in turn makes it possible to reliably use the package e.g. as a rice bag or any other package for storing heavy products.

### BRIEF DESCRIPTION OF THE DRAWINGS

FIG. 1 is an exploded perspective view of a bag material according to the present invention, showing its components.

FIG. 2 is a partial perspective view of a bag material embodying the invention.

FIG. 3 is an enlarged partial plan view of the bag material of FIG. 2.

FIG. 4(a) is an enlarged sectional view taken along line X-X of FIG. 3, and FIG. 4(b) is an enlarged sectional view taken along line Y-Y of FIG. 3.

FIG. 5 is an enlarged sectional view taken along line Z-Z of FIG. 3.

FIG. 6 is a perspective view of a package formed from the bag material of FIG. 2.

FIG. 7 shows how the package of FIG. 6 is hand-carried.

FIG. 8 is a partial perspective view of another bag material embodying the present invention.

### DESCRIPTION OF THE NUMERALS

1. Front sheet
2. Back sheet
3. Sheet strip
4. First heat-bonded portion
5. Second heat-bonded portion
6. Tube body
7. Bonded portion
8. Unbonded portion
9. Air vent hole
10. Packaging bag material
11. Package with a carrying handle
12. Carrying handle
13. Rice
14. Window
M. Mark indicating the cut line

### BEST MODE FOR EMBODYING THE INVENTION

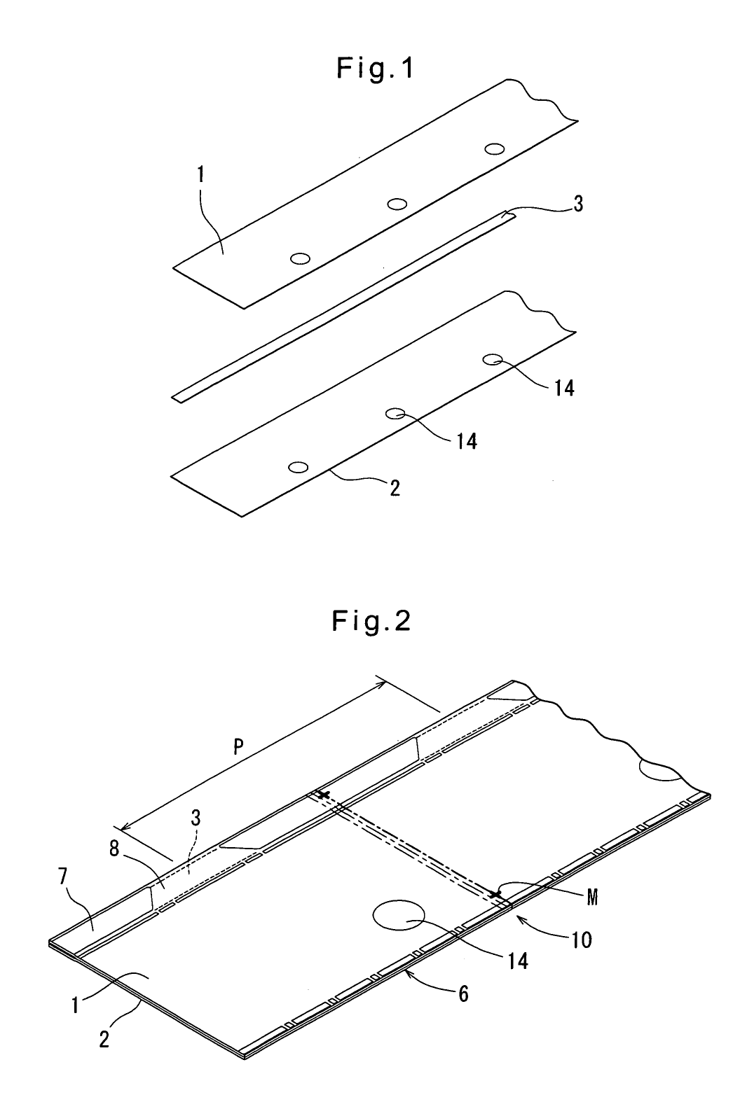

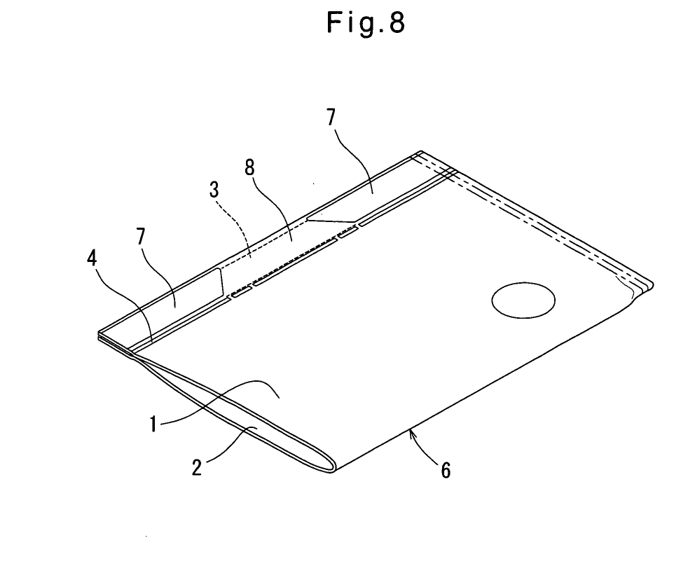

The packaging bag material embodying the present invention is now described with reference to FIGS. 1 to 8. As shown in FIG. 1, the packaging bag material 10 comprises an elongated front sheet 1, a back sheet 2 superposed on the front sheet 1, and a strip of sheet 3 with a predetermined width.

The front sheet 1 and the back sheet 2 are made of synthetic resin films that can be heat-bonded to each other. The synthetic resin films may be composite films each comprising a heat-bondable polyethylene film and a reinforcing material (such as a nylon film, polyester film or fiber sheet) integrally laminated on the polyethylene film.

The front sheet 1 and the back sheet 2 are preferably made, for the most part, of an opaque or translucent material and partly made of a transparent material as a window 14 to minimize photodegradation of the contents of the bag while simultaneously allowing easy checking of the contents from outside.

The sheet strip 3 is used as a carrying handle. Thus, it has to have sufficient strength for this purpose and has to be heat-bondable to the front and back sheets 1 and 2. The sheet strip 3 may be one proposed by the applicant in the above-mentioned Patent document 2, i.e. non-woven fabric formed by laminating and embossing filaments comprising high-toughness polyester coated with high-density polyethylene. The sheet strip 3 may be formed by cutting a wide non-woven fabric to a predetermined width of e.g. about 10-50 mm with a slitter. Non-woven fabrics usable for the sheet strip 3 typically weigh 100 g/m², 70 g/m², 50 g/m², 30 g/m² and 20 g/m². From these non-woven fabrics, one having suitable strength is selected and used. When used for a rice bag, the carrying handle has to withstand loads of about 1 to 10 kg. For this purpose, a non-woven fabric that weighs 100 g/m² to 50 g/m² is preferably used.

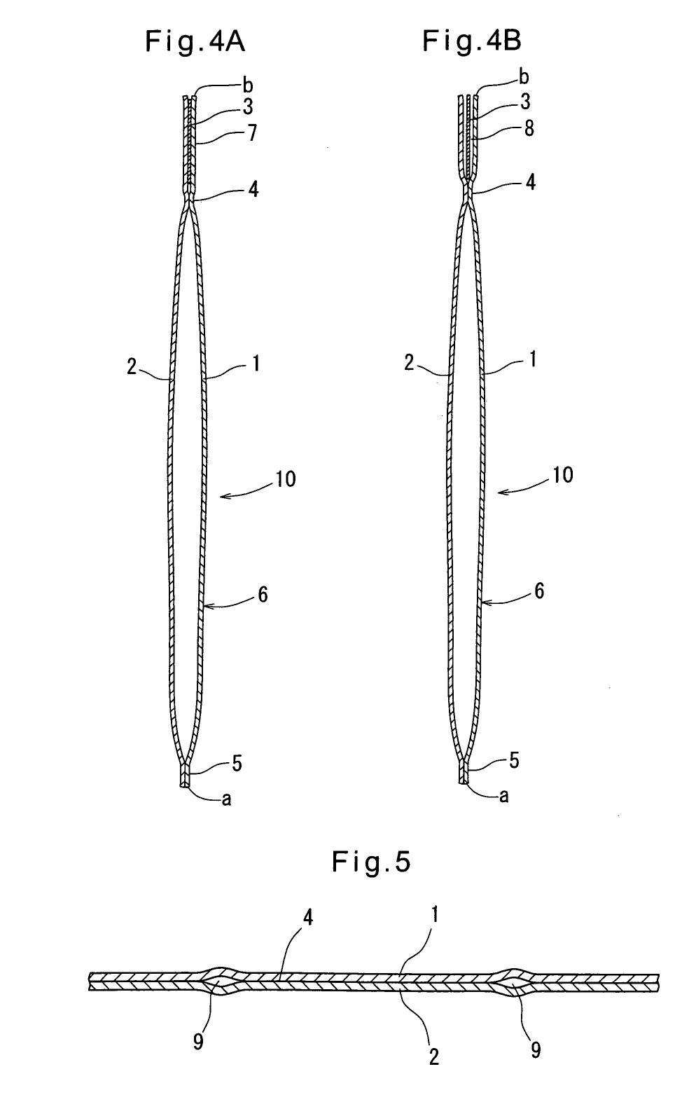

The front and back sheets 1 and 2 shown in FIG. 1 are superposed one on the other and coupled together by heat-bonding the sheets 1 and 2 adjacent to and along their first and second side edges a and b, respectively, as shown in FIGS. 4(a) and 4(b). Numeral 4 in FIGS. 2-4 and 6 indicates a first heat-bonded portion provided adjacent to and extending along the second side edges b. Numeral 5 indicates a second heat-bonded portion provided adjacent to and extending along the fist side edges a. By coupling the sheets 1 and 2 together in the above manner, an elongated flat tube body 6 is obtained.

The first heat-bonded portion 4 is spaced from the second side edge of the tube body 6 in the width direction by a predetermined distance toward the first side edge. The sheet strip 3 is disposed between the portions of the sheets 1 and 2 extending from the first heat-bonded portion 4 toward the second side edge with its longitudinal direction coincident with the longitudinal direction of the tube body 6. The front sheets 1 and 2 are bonded to the sheet strip 3 disposed therebetween at bonded portions 7 having a predetermined length and longitudinally spaced from each other with a predetermined pitch, thereby defining unbonded portions 8 between the adjacent bonded portions 7.

The unbonded portions 8 are arranged with a pitch of P (FIG. 2) that is equal to the length of each packaging bag formed. The unbonded portions 8 each have a length sufficient for a person to be able to insert the palm of his or her hand into the unbonded portion 8.

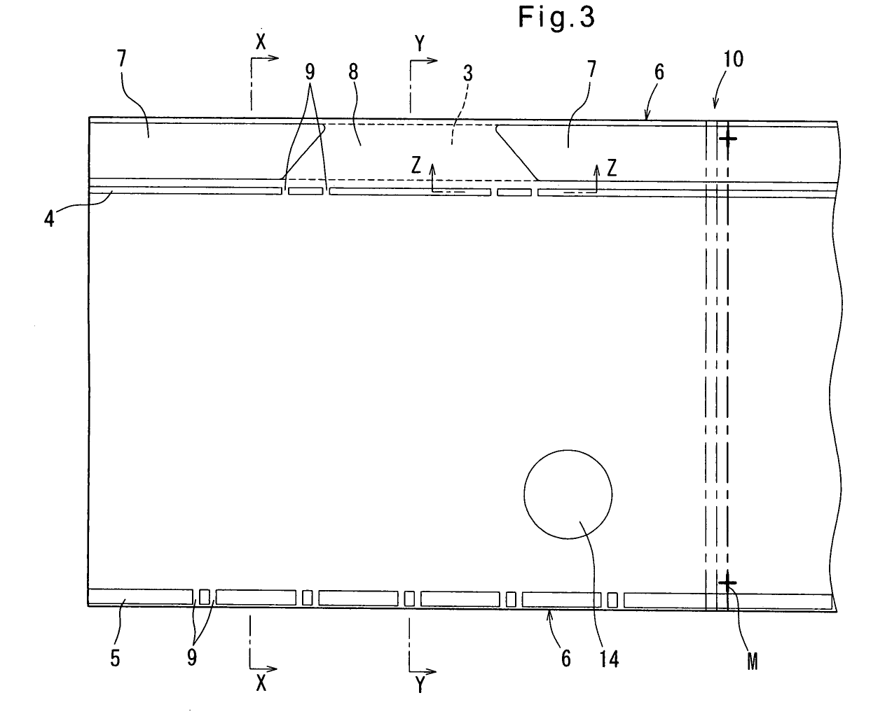

Air vent holes 9 may be formed as shown in FIGS. 3 and 5. The air vent holes 9 are formed in the first and second heat-bonded portions 4 and 5 so as to be longitudinally spaced from each other, thereby defining longitudinally spaced unbonded portions and thus dividing each of the first and second heat-bonded portions into a plurality of longitudinally spaced sections. The air vent holes 9 have to be sufficiently small such that the contents of the bags would not spill out therethrough. In the embodiment, the air vent holes 9 formed in the first heat-bonded portions 4 are located at positions corresponding to the unbonded portions 8. But instead, the air vent holes 9 formed in the first heat-bonded portions 4 may be located at positions corresponding to the bonded portions 7 with the respective bonded portions 7 divided by unbonded portions communicating with the air vent holes 9.

The packaging bag material 10 of the embodiment is formed in the above-described manner (by heat-bonding necessary portions), which comprises a large number of uncompleted packaging bags connected to each other and aligned in the longitudinal direction of the bag material. The bag material 10 is wound in a roll and set in an automatic weighting/packaging device (roll packer) and used by unwinding the roll.

When the bag member is unwound, a portion of the bag member that serve as the bottom edge of one bag is heat-bonded, and then the bag member is cut apart in the direction perpendicular to the longitudinal direction of the bag member at an intermediate point between the adjacent unbonded portions 8 in front and rear of the bottom edge of the one bag with respect to the feed direction of the bag member. (This intermediate point is preferably marked with the letter M so that the actual cutting position is easily adjustable.) Contents are then put in the thus cut apart bag with its mouth at the top open. When the bag is filled with the contents, the bag is sealed by heat-bonding its top edge. A package with a carrying handle which is filled with contents is now complete.

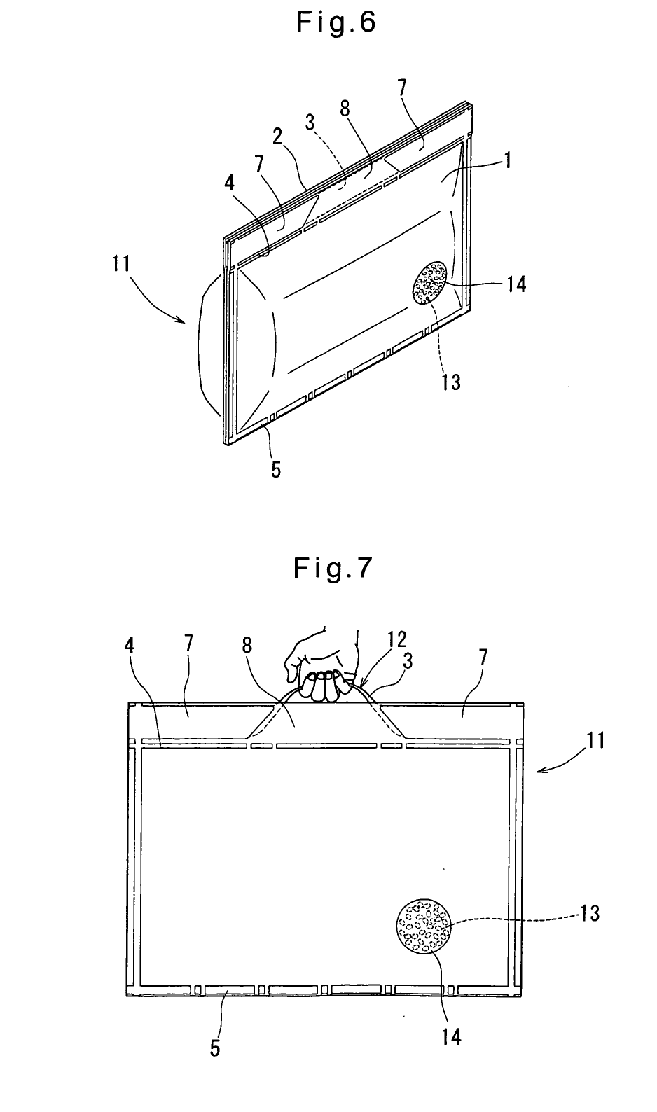

FIG. 6 shows the thus completed package 11 with a carrying handle. With this package 11, the sheet strip 3, which is provided along the second side edge of the tube body, can be pulled out through the space between the front and back sheets 1 and 2. By pulling out the sheet strip 3, it is possible to hand-carry the package 11 by using the sheet strip 3 as a carrying handle 12 as shown in FIG. 7. In FIG. 6, the package is filled with rice 13. But the contents of the package are not limited to rice or other grains. It can contain products other than grains, such as chopped or minced food products, dried feeds or toilet sand for pets such as dogs and cats, dirt or manure for gardening, or any other products that are ordinarily sold in bags.

With the bag material 10 of the embodiment, the sheet strip 3 has a width equal to the portion of the tube body 6 from its first heat-bonded portion 4 to second side edge. With this arrangement, since the sheet strip 3 is completely concealed by the front and back sheets 1 and 2, the sheet strip 3 does not impair the appearance of the package 11, and also does not hinder the packaging of products in the package. Further, the bag material can be easily and smoothly wound and unwound. To achieve the same results, the sheet strip 3 may have a smaller width than the portion of the tube body 6 from its first heat-bonded portion 4 to the second side edge of the tube body 6.

The tube body 6 forming the packaging bag material 10 may comprise a wide and elongated single film sheet which is folded in half in the width direction to form front and back sheets that are superposed one on anther. In this arrangement too, the sheet strip, which can be used as a carrying handle, is disposed between the front and back sheets 1 and 2 along the second side edges of the tube body 6. This tube body 6 needs no second heat-bonded portion 5 for bonding the sheets together along the first side edge.

1. A packaging bag material comprising an elongated flat tube body (6) made of a resin film and including a front sheet (1) and a back sheet (2), and a sheet strip (3) forming a carrying handle (12), wherein said tube body (6) has first and second side edges (a) and (b), and a first heat-bonded portion (4) where portions of said front and back sheets (1) and (2) adjacent to said second side edge (b) are bonded to each other, said first heat-bonded portion (4) being spaced apart from the second side edge (b) toward the first side edge (a) in the width direction by a predetermined distance, wherein said sheet strip (3) is disposed between portions of said front and back sheets (1) and (2) extending from said first heat-bonded portion (4) toward said second side edge (b) with a longitudinal direction of the strip sheet coincident with a longitudinal direction of said tube body, and wherein said front and back sheets (1) and (2) are bonded to the sheet strip (3) disposed therebetween at bonded portions (7) having a predetermined length and longitudinally spaced from each other with a predetermined pitch, thereby defining unbonded portions (8) between the adjacent bonded portions (7), whereby said sheet strip (3) can be pulled out from between the front and back sheets (1) and (2) through the respective unbonded portions (8), the entire packaging bag material can be wound into a roll, and a packaging bag with a carrying handle can be formed by cutting the bag member in a direction perpendicular to said longitudinal direction of the tube body along a line between any adjacent unbonded portions (8) and heat-sealing the front and back sheet together at their portions adjacent to and along the cut line.

2. The packaging bag material of claim 1 wherein said sheet strip (3) has a width that is equal to or smaller than the dimension of the portion of the tube body (6) from said first heat-bonded portion (4) to said second side edge (b) and does not protrude from between said front and back sheets (1) and (2).

3. The packaging bag material of claim 1 wherein said tube body (6) has a second heat-bonded portion (5) where said front and back sheets (1) and (2) are joined to each other along said first side edge, and wherein at least one of said first and second heat-bonded portions (4) and (5) is divided into a plurality of longitudinally spaced apart sections, thereby defining air vent holes (9) between the adjacent sections, said air vent holes being of a size small enough not to allow spilling of contents of the bag therethrough.

4. A package with a carrying handle formed by cutting the packaging bag material (10) of claim 1 in the direction perpendicular to said longitudinal direction of the tube body along two cut lines each between adjacent ones of said unbonded portions (8), filling a bag, heat-sealing the front and back sheets together at their portions adjacent to the respective two cut lines, thereby forming a bag of which all the four sides are closed, and the sheet strip (3) can be pulled out from between said front and back sheets (1) and (2) as a carrying handle (12).

5. The package with a carrying handle of claim 4 wherein said package is a rice bag which contains a predetermined amount of rice (13).

6. The packaging bag material of claim 2 wherein said tube body (6) has a second heat-bonded portion (5) where said front and back sheets (1) and (2) are joined to each other along said first side edge, and wherein at least one of said first and second heat-bonded portions (4) and (5) is divided into a plurality of longitudinally spaced apart sections, thereby defining air vent holes (9) between the adjacent sections, said air vent holes being of a size small enough not to allow spilling of contents of the bag therethrough.

7. A package with a carrying handle formed by cutting the packaging bag material (10) of claim 2 in the direction perpendicular to said longitudinal direction of the tube body along two cut lines each between adjacent ones of said unbonded portions (8), filling a bag, heat-sealing the front and back sheets together at their portions adjacent to the respective two cut lines, thereby forming a bag of which all the four sides are closed, and the sheet strip (3) can be pulled out from between said front and back sheets (1) and (2) as a carrying handle (12).

8. A package with a carrying handle formed by cutting the packaging bag material (10) of claim 3 in the direction perpendicular to said longitudinal direction of the tube body along two cut lines each between adjacent ones of said unbonded portions (8), filling a bag, heat-sealing the front and back sheets together at their portions adjacent to the respective two cut lines, thereby forming a bag of which all the four sides are closed, and the sheet strip (3) can be pulled out from between said front and back sheets (1) and (2) as a carrying handle (12).
